(19) United States
(12) Patent Application Publication
(10) Pub. No.: US 2006/0197742 A1
(43) Pub. Date: Sep. 7, 2006

(54) Computer pointing input device

(76) Inventor: Robert H. Gray III, McDonough, GA (US)

Correspondence Address: LITMAN LAW OFFICES, LTD, PO BOX 15035, CRYSTAL CITY STATION, ARLINGTON, VA, 22215, US

(21) Appl. No.: 11/071,467

(22) Filed: Mar. 4, 2005

(51) Int. Cl. G09G 5/08

(52) U.S. Cl. 345/157

(57) ABSTRACT

The computer pointing input device allows a user to determine the position of a cursor on a computer display. The position of the input device in relation to the display controls the position of the cursor, so that when a user points directly at the display, the cursor appears at the intersection of the display and the line of sight from of the input device. When the device is moved, the cursor appears to move on the display in exact relation to the input device. In addition, a cursor command unit allows the user to virtually operate the input device wherein changes in the position of the device allow the user to spatially invoke mouse functions. The computer pointing input device is designed to operate with a computer having a processor through a computer communication device.

### BACKGROUND OF THE INVENTION

1. Field of the Invention

The present invention relates to a computer peripheral device, and particularly to a computer pointing input device that maintains the cursor on the display with the line of sight of the input device.

2. Description of the Related Art

Numerous computer input devices exist that allow a user to control the movement of a cursor image on a computer display. The conventional input devices use a mechanical device connected to the housing, such as a roller ball, which, when moved about a mouse pad, determines the direction in which the cursor image is to move. Additionally, typical input devices have user-activating buttons to perform specific cursor functions, such as a “double click.”

The conventional input devices have given way, in recent years, to optical technology. The newer devices LAW obtain a series of images of a surface that are compared to each other to determine the direction in which the input device has been moved. However, both types of input devices require that the user be tied to the desktop, as a mouse pad is still necessary.

Although some input devices do exist that are not tied to a desktop, the devices do not allow for a cursor image to almost instantaneously follow along the line of sight of the device. Causing the cursor image to be positioned at the intersection of the line of sight of the input device and the display allows a user to more accurately control the direction the cursor image is to move, as the user is able to ascertain quickly where the cursor image is and where the user would like the cursor image to go.

Further, computer input devices generally use a user-controlled wheel or a set of buttons to invoke mouse functions. After repeated use, however, these buttons or wheels often tend to stick, causing problems for the user. Additionally, use of the buttons and wheels may not be the most efficient or ergonomic method of invoking mouse functions.

Accordingly, there is a need for a computer pointing input device that aligns a cursor image directly with the line of sight of the device and also allows for a user to spatially invoke mouse functions. Thus, a computer pointing input device solving the aforementioned problems is desired.

### SUMMARY OF THE INVENTION

The computer pointing input device allows a user to determine the position of a cursor on a computer display. The position of the input device in relation to the display controls the position of the cursor, such that when a user points directly at the display, the cursor appears at the intersection of the display and the line of sight from an aiming point of the input device. When the device is moved, the cursor appears to move on the display in exact relation to the input device. In addition, a cursor command unit allows the user to virtually operate the input device so that changes in the position of the device invoke mouse functions. The computer pointing input device is designed to operate with a computer having a processor through a computer communication device.

The input device includes a housing and may include an image-capturing component. The input device additionally may include an internal processing unit, a battery, an array component, an array aperture, a wireless or wired communication device and the cursor command unit. The housing may have a front aperture, a rear aperture or an aperture in any portion of the housing that would allow the input device to obtain images. The image-capturing component acquires images from the appropriate aperture for the method of image acquisition used. The image-capturing component may include multiple illuminators that illuminate a surface in front of the device when the image-capturing component acquires an image through the front aperture, or behind the device when the image-capturing component acquires an image through the rear aperture.

The computer pointing input device may additionally include a rotating ball connected to the end of the input device. The rotating ball may have illuminators and a rear aperture, such that an image may be acquired through the rear aperture of the device. The input device may include a transmitter that communicates wirelessly with the computer or a cable connecting the device directly to the computer. The device may additionally have a traditional mouse wheel and traditional mouse buttons on the housing so that a user is able to optionally utilize these additional features.

The present invention makes use of various methods of aligning the cursor image along the line of sight of the computer pointing input device. In a first method, the device obtains a picture of the cursor image and uses the picture of the cursor image itself to align the device and the cursor. The computer pointing input device is aimed at the display. The image-capturing component continuously acquires pictures of the area on the display in the field of vision through the front aperture along the line of sight of the device. The picture is conveyed to the processor through the wired or wireless communication device. A dataset center zone of the field of vision is determined. The processor then scans the image to determine whether the mouse cursor image is found within each successive image conveyed to the processor. When the cursor image is found, a determination is made as to whether or not the center coordinates of the cursor object are within the dataset center zone of the image. If the center coordinates of the cursor image are found within the center zone of the field of vision image, the device is thereafter “locked” onto the cursor image. p Once the device is “locked”, the processor is able to take into account movement of the device and move the cursor image directly with the device. After the pointing device is “locked”, coordinates are assigned for the area just outside the boundary of the cursor object and saved as a cursor boundary dataset. The device may then be moved, and the processor determines whether the cursor image is found within the loaded images. When the cursor image is found, then the cursor object coordinates are compared to the cursor boundary dataset, and if any of the cursor object edge coordinates correspond with the cursor boundary coordinates, then the processor is notified that the cursor object has moved out of the center of the field of vision and the cursor object is moved in a counter direction until it is again centered.

The second method of aligning the cursor image with the device is to first “lock” the input device with the cursor image. Before the device is activated, the user holds the device in such a way that the line of sight of the device aligns with the cursor image. The device is then activated. Images are acquired either through the front aperture from a surface in front of the device, through the rear aperture from a surface in back of the device, or may be acquired through any aperture built into the housing from a surface viewed through the aperture and may be illuminated by the illuminators. The array aperture, located on the side of the array component closest to the aperture through which the images are acquired, focuses the images onto the array component. As noted above, the array aperture is an optional component. The images are converted by the internal processing unit to a format readable by the processor, and the information is transmitted to the processor by the wired or wireless communication device. Successive images are compared, and the processor is able to determine changes in the direction of the device based on the slight variations noted between successive images acquired as a result of the movement of the device away from the zeroed point determined at the first “locked” position. The processor then moves the cursor object based on the movement of the input device.

In a third method of aligning the cursor image with the line of sight of the device, the device uses infrared, ultrasonic, or radio transmitters in conjunction with a sensor array attached to the monitor to determine the line of sight of the device. The ranges, or distances from points on the device to the monitor, are determined, and a vector is calculated through the points and the monitor. The x and y coordinates of the intersection of the vector and the display are determined, and when the input device is moved, the cursor image is directed by the processor to move in line with the line of sight of the device. While a vector through points on the device is discussed, the position of the device may be determined through any method that uses transmitters situated on the device and a sensor array. In alternate embodiments, the sensor array may be positioned on a desk top, behind the device or in any location so that the sensor array can pick up the signals sent by the transmitters to the sensor array and thereby determine the position of the input device.

The cursor command unit allows a user to operate the computer pointing input device without traditional mouse buttons. The cursor command unit includes an infrared, ultrasonic, radio or magnetic transmitter/receiver unit. A signal is sent out from the cursor command unit and reflected back to the unit for the infrared, ultrasonic, or radio units. A disturbance is sent from the device when a magnetic unit is used. Either the processor, the cursor command unit or the internal processing unit is able to determine changes in distance from the cursor command unit to the display when the device is moved between a first distance and a second distance. Time intervals between distances are also determined. The information as to distance and time intervals is sent to the processor, and depending on the difference in distances and the time intervals between distances, the processor is instructed to execute a specific cursor command.

These and other features of the present invention will become readily apparent upon further review of the following specification and drawings.

### BRIEF DESCRIPTION OF THE DRAWINGS

FIG. 1 is an environmental, perspective view of a computer pointing input device according to the present invention.

FIG. 2 is a block diagram of a typical computer system for use with the computer pointing input device according to the present invention.

FIG. 3 is a detailed perspective view of the computer pointing input device according to a first embodiment of the present invention.

FIG. 4 is an exploded view of the computer pointing input device of FIG. 3.

FIG. 5 is a detailed perspective view of a computer pointing input device according to a second embodiment of the present invention.

FIG. 6 is a detailed perspective view of a computer pointing input device according to a third embodiment of the present invention.

FIG. 7 is a flowchart of a first method of aligning the cursor image with the computer pointing input device according to the present invention

FIG. 8 is a flowchart showing a continuation of the first method of aligning the cursor image with the computer pointing input device according to the present invention.

FIG. 9 is an environmental, perspective view of the computer pointing input device according to the present invention showing a sensor array disposed on the monitor.

FIG. 10 is a flowchart of a second method of aligning the cursor image with the computer pointing input device according to the present invention.

FIG. 11 is a flowchart of the operation of the cursor command unit of the computer pointing input device according to the present invention.

Similar reference characters denote corresponding features consistently throughout the attached drawings.

### DETAILED DESCRIPTION OF THE PREFERRED EMBODIMENTS

The present invention is a computer pointing input device that allows a user to determine the position of a cursor on a computer display. The position of the input device in relation to the display controls the position of the cursor, so that when a user points directly at the display, the cursor appears at the intersection of the line of sight of the input device and the display. When the device is moved, the cursor appears to move on the display in exact relation to the input device. In addition, a cursor command unit allows the user to virtually operate the input device. Changes in the position of the device allow the user to spatially invoke mouse functions.

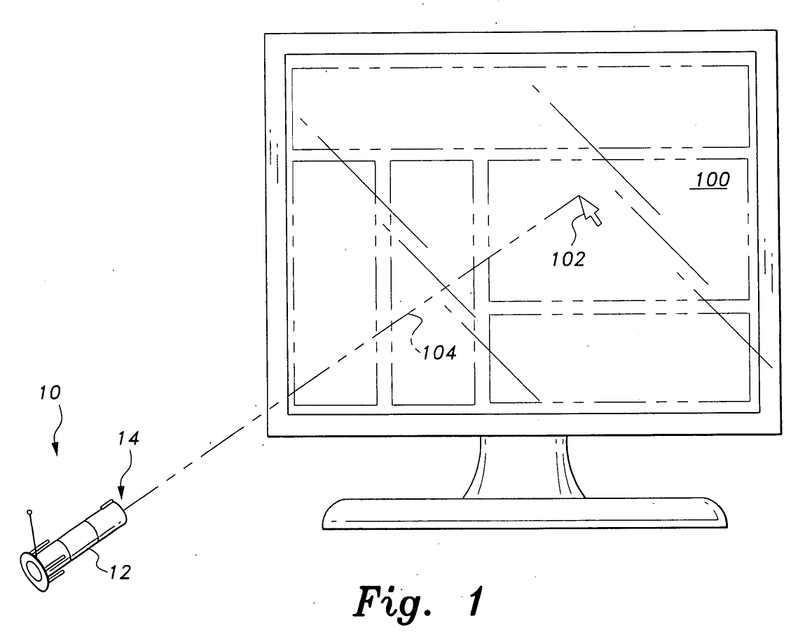

Referring first to FIG. 1, an environmental, perspective view of the computer pointing input device 10 is shown. The input device 10 includes a housing 12 having a front aiming point 14. After the device 10 is activated, when the device 10 is aimed at the display 100, the cursor 102 appears to align along the line of sight 104 of the aiming point 14 of the input device 10. Upon movement in any direction of the device 10, the cursor 102 will reposition at the intersection of the line of sight 104 between the aiming point 14 and the display 100. While a cursor image is discussed, the device 10 may be used with any visual object shown on a display 100.

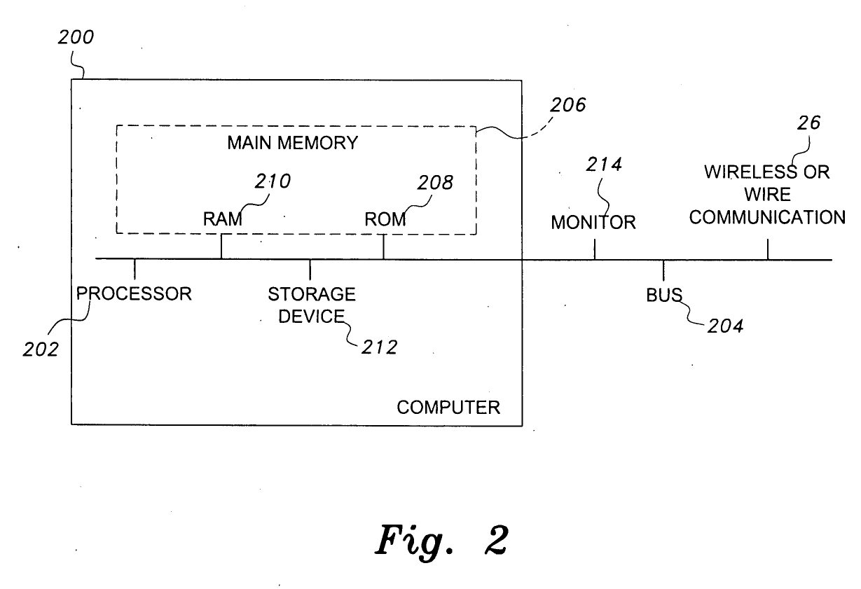

The computer pointing input device 10 is designed to operate with a computer through a wired or wireless communication device 26. FIG. 2 shows a typical personal computer system for use in carrying out the present invention.

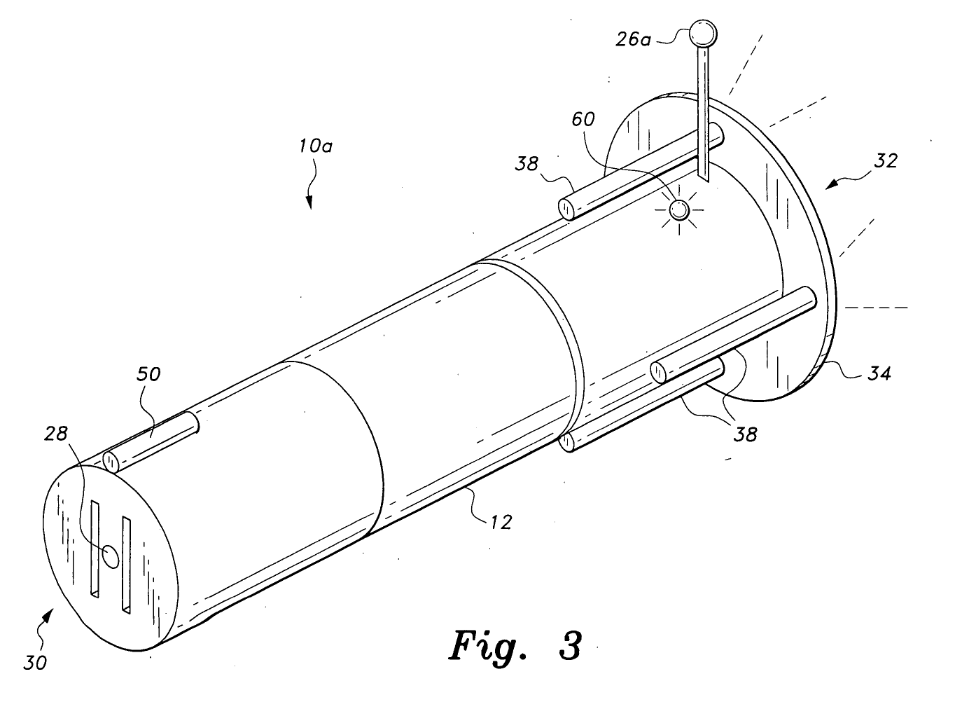

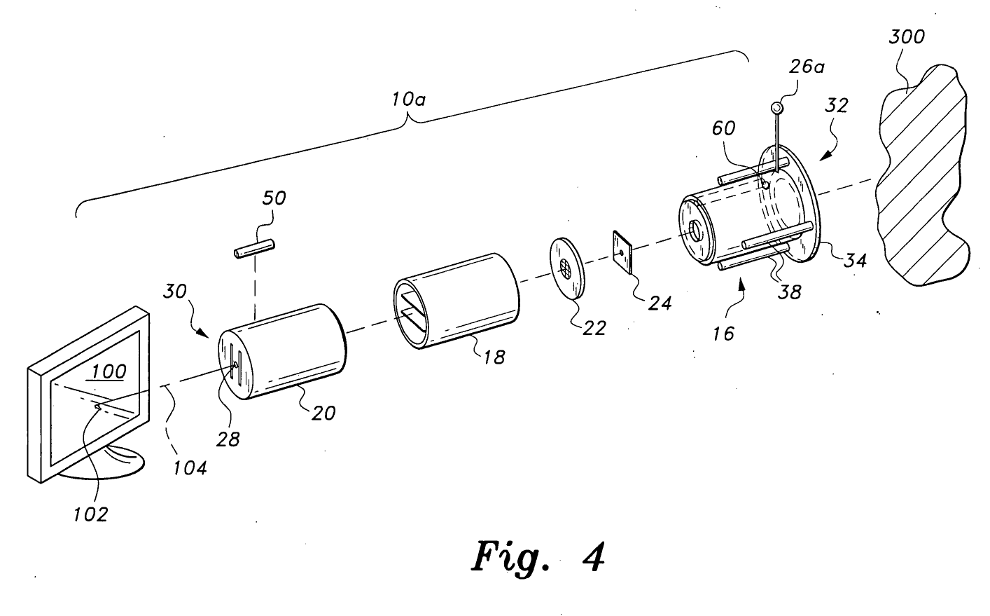

The personal computer system is a conventional system that includes a personal computer 200 having a microprocessor 202 including a central processing unit (CPU), a sequencer, and an arithmetic logic unit. (ALU), connected by a bus 204 or buses to an area of main memory 206 for executing program code under the direction of the microprocessor 202, main memory 206 including read-only memory (ROM) 208 and random access memory (RAM) 210. The personal computer 200 also has a storage device 212. The personal computer system also comprises peripheral devices, such as a display monitor 214. The personal computer 200 may be directly connected to the computer pointing input device 10 through a wireless or wired communication device 26, such as a transmitter 26a (shown more clearly in FIGS. 3 and 4) connected to the device 10 for transmitting information and a receiver connected to the personal computer 200 for receiving the information sent by the transmitter, or may be a wired connection, such as a 1394, USB, or DV cable. While a personal computer system is shown, the device 10 may operate with any system using a processor.

It will be understood that the term storage device 212 refers to a device or means for storing and retrieving data or program code on any computer readable medium, and includes a hard disk drive, a floppy drive or floppy disk, a compact disk drive or compact disk, a digital video disk (DVD) drive or DVD disk, a ZIP drive or ZIP disk, magnetic tape and any other magnetic medium, punch cards, paper tape, memory chips, or any other medium from which a computer can read.

Turning now to FIGS. 3-6, various embodiments of the computer-pointing input device 10 are shown. FIG. 4 shows an exploded view of the components of the device 10. A computer 100 is shown diagrammatically in FIG. 4 for purposes of illustration, and is not drawn to scale. While FIG. 4 shows the numerous components that make up the structure of the device 10, not every component shown in FIG. 4 is essential to the device 10, and certain components may be subtracted or arranged in a different manner depending on the embodiment of the device 10 involved, as will be explained below.

FIGS. 3 and 4 are perspective and exploded views, respectively, of a first embodiment of the computer pointing input device 10a. The input device 10a has a housing 12 and may include an image-capturing component 16. The input device 10a additionally may include an internal processing unit 18, a battery 20, an array component 22, an array aperture 24, a wireless or wired communication device 26 (a wireless device 26a being shown in FIGS. 3 and 4) and a cursor command unit 50.

The housing 12 may be any of a number of housing devices, including a handheld mouse, a gun-shaped shooting device, a pen-shaped pointer, a device that fits over a user's finger, or any other similar structure. The housing 12 may have a front aperture 28 defined within the front end 30 of the housing 12 or a rear aperture 32 defined within the back end 34 of the housing 12. Although front 28 and rear 32 apertures are shown, an aperture capable of obtaining images through any position from the housing may be used. While both the front 28 and rear 32 apertures are shown in FIG. 4, generally only one of the two apertures 28 and 32 is necessary for a given embodiment of the present invention. If the front aperture 28 is defined within the front end 30 of the housing 12, the front aperture 28 is the aiming point 14 of the device 10a.

The image-capturing component 16 is disposed within the housing 12. The image-capturing component 16 may be one of, or any combination of, a ray lens telescope, a digital imaging device, a light amplification device, a radiation detection system, or any other type of image-capturing device. The image-capturing component 16 acquires images from the front aperture 28, the rear aperture 32, or an aperture built into some other portion of the housing 12, based upon the method of image acquisition used. The image-capturing component 16 may be used in conjunction with the array component 22 and the array aperture 24, or the array component 22 and array aperture 24 may be omitted, depending on the method through which the device 10 aligns itself along the line of sight 104 of the device 10.

The array component 22 may be a charge-coupled device (CCD) or CMOS array or any other array capable of detecting a heat, sound, or radiation signature that is conveyed to the internal processing unit 18. When the array component 22 and the array aperture 24 are utilized, the array aperture 24 creates a focal point of the image being acquired. The array aperture 24 is disposed next to the array component 22 on the side of the array component 22 through which the image is being captured. As shown in FIG. 4, if an image, for example, image 300, is being acquired through the rear aperture 32, the array aperture 24 is positioned on the side of the array component 22 that is closest to the rear aperture 32. If an image, for example, display 100, is being acquired through the front aperture 28, the array aperture 24 is positioned on the side of the array component 22 that is closest to the front aperture 28.

The image-capturing component 16 may include multiple illuminators 38 that illuminate a surface, for example, display 100, in front of the device 10 when the image-capturing component 16 acquires an image through the front aperture 28 and the image requires illumination in order to be acquired. The illuminators 38 may illuminate a surface, for example, image 300, from the back of the input device 10 when the image-capturing component 16 acquires an image from the rear aperture 32. Image 300 may be any image obtained from behind the computer pointing device 10, for example, a shirt, a hand, or a face. Additionally, if the aperture is defined within the housing other than in the front or the rear of the housing, the image is obtained from the surface (i.e., a wall or ceiling) seen through the aperture.

The wireless or wire communication device 26 may be a transmitter 26a connected to the input device 10a for use with a receiver connected to the processor 202. A device status light 60 may be located on the housing 12 of the device 10. The cursor command unit 50 may be retained on the front of the unit.

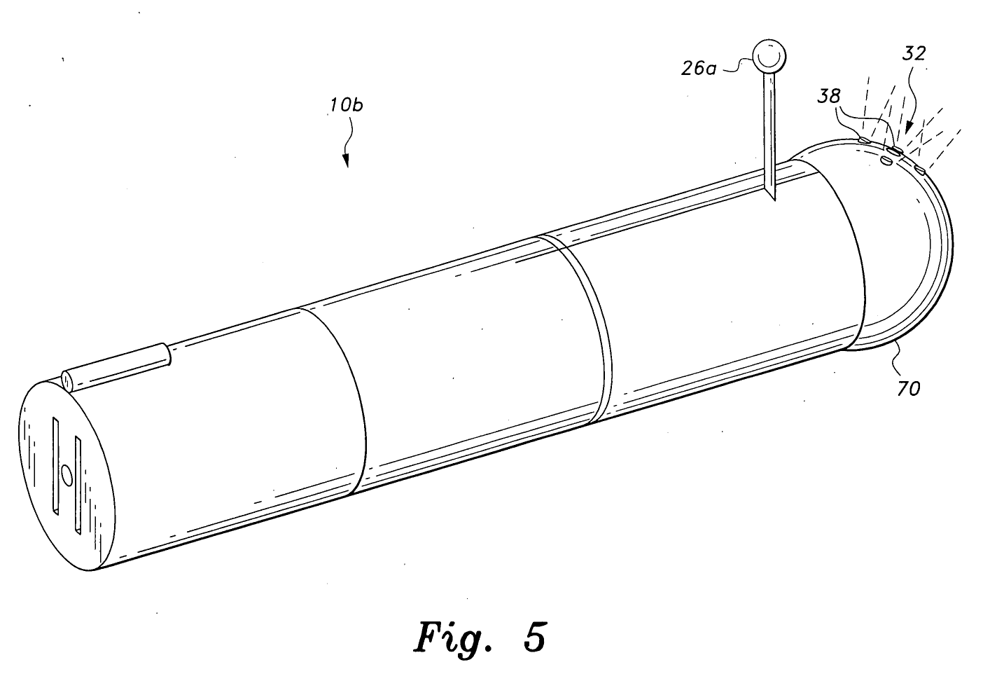

Turning now to FIG. 5, a second embodiment of the computer pointing input device 10b is shown. In this embodiment, a rotating ball 70 is connected to the end of the input device 10b. The ball 70 includes illuminators 38 on the ball 70 and a rear aperture 32, so that an image may be acquired through the rear aperture 32 of the device lob. The ball 70 may be rotated to create a better position to obtain the image.

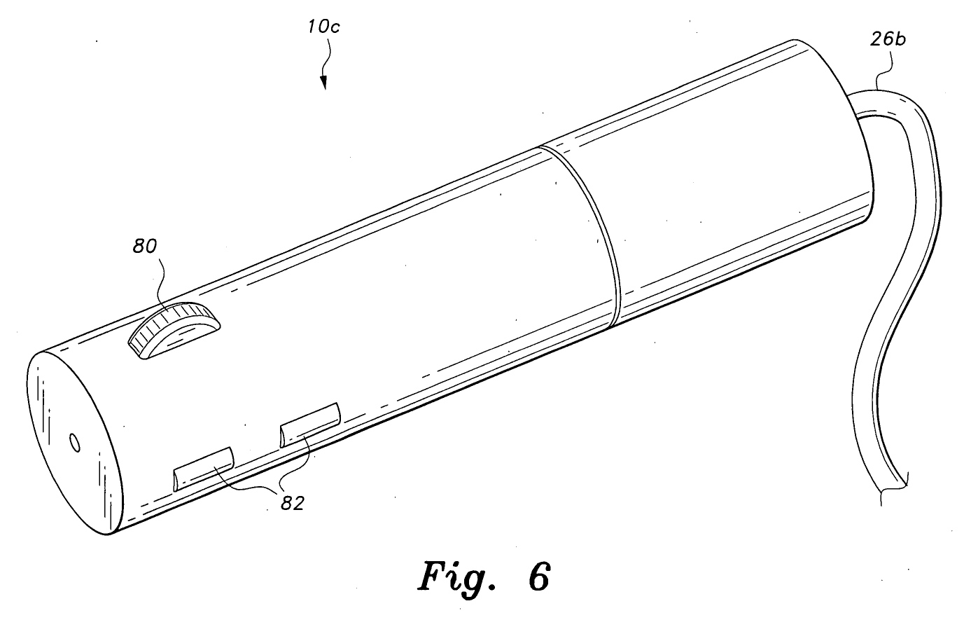

FIG. 6 shows a third embodiment of the computer pointing input device 10c. The device 10c omits the transmitter 26a and substitutes a cable 26b wired directly to the processor 202. In this embodiment, the battery 20 is an unnecessary component and is therefore omitted. Additionally, a traditional mouse wheel 80 and traditional mouse buttons 82 are provided on the housing 12 so that a user is able to optionally utilize these additional features.

While FIGS. 3-6 show a number of embodiments, one skilled in the art will understand that various modifications or substitutions of the disclosed components can be made without departing from the teaching of the present invention. Additionally, the present invention makes use of various methods of aligning the cursor image 102 along the line of sight 104 of the computer pointing input device 10.

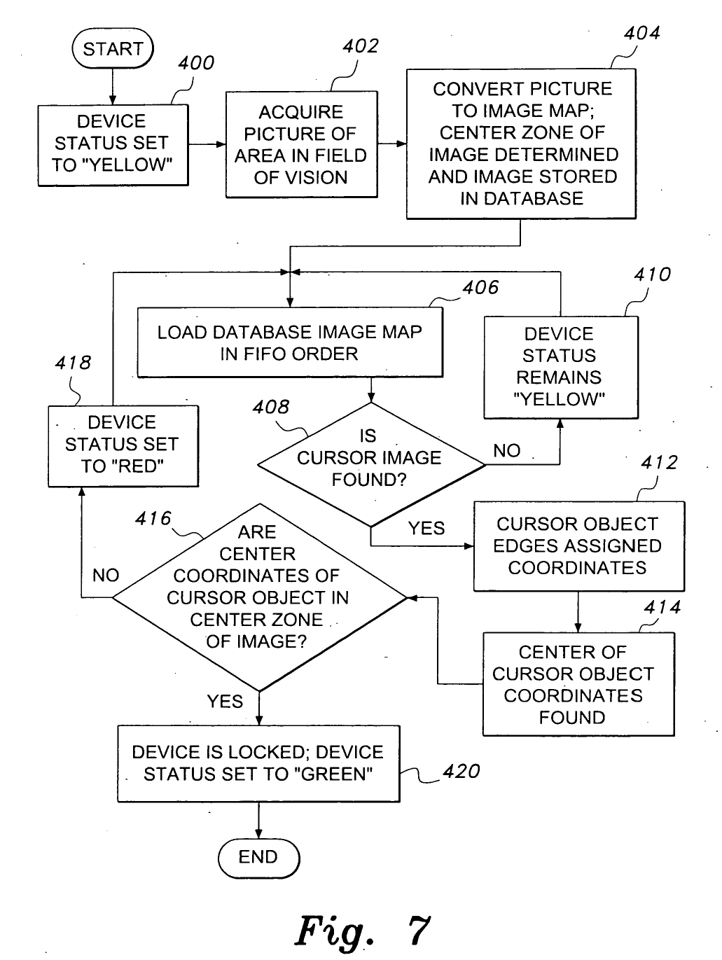

In a first method, the device 10 obtains a picture of the cursor image 102 and uses the picture of the cursor image 102 to align the device 10 and the cursor 102. This method does not require use of the array component 22 and the array aperture 24, and may not require use of the internal processing unit 18. FIG. 7 shows a flowchart illustrating the steps of the method of aligning the cursor image 102 with the line of sight 104 of the device 10 by image acquisition of the cursor image 102 itself. At 400, the status light 60 of the device is set to “yellow”. Setting the status light 60 to “yellow” notifies the user that the cursor image 102 has yet to be found within the field of vision of the device 10. The computer pointing input device 10 is aimed at the display 100. The image-capturing component 16 continuously acquires pictures of the area on the display in the field of vision through the front aperture 28 along the line of sight 104 of the device 10, as indicated at 402. The picture is conveyed to the processor 202 through the wired or wireless communication device 26.

Software loaded on the processor 202 converts the picture to a gray-scale, black and white or color image map at step 404. A center point of the field of vision of each image acquired is determined, the center point being a coordinate of x=0, y=0, where x=0, y=0 is calculated as a coordinate equidistant from the farthest image coordinates acquired within the field of vision at 0, 90, 180 and 270 degrees. A center zone is determined by calculating coordinates of a small zone around the center point and saving these coordinates as a dataset. Each image is then stored in a database.

At step 406, the database image map is loaded in FIFO (first in, first out) order. The processor 202 then scans the image map at step 408 to determine whether the mouse cursor image 102 is found within each successive image conveyed to the processor 202. If the cursor image 102 is not found, the status light 60 located on the device 10 remains “yellow” at step 410, and the processor 202 is instructed to load the database image map again. If the cursor image 102 is found within the image map, as indicated at step 412, the cursor object edges are assigned coordinates and saved as a cursor object edges dataset. At step 414, the x and y coordinates of the center of the cursor object 102 are found. At step 416, a determination is made as to whether or not the center coordinates of the cursor object 102 are within the dataset center zone of the image calculated at step 404. If the center coordinates of the cursor object 102 are not determined to be within the center zone of the image, the device status light 60 is set to “red” at 418, notifying the user that the “lock-on” is near and the cursor object 102 is close to being centered along the line of sight 104 of the device 10. If the center coordinates are found within the center zone of the image, at 420, the device 10 is “locked” and the device status light 60 is set to “green,” notifying the user that the device 10 has “locked” onto the cursor image 102.. The device 10 being “locked” refers to the fact that the line of sight 14 of the computer pointing input device 10 is aligned with the cursor image 102 displayed on the screen.

While the status light makes use of “red,” “yellow,” and “green” settings, any other convenient indicator of status may be used in place of these indicating settings.

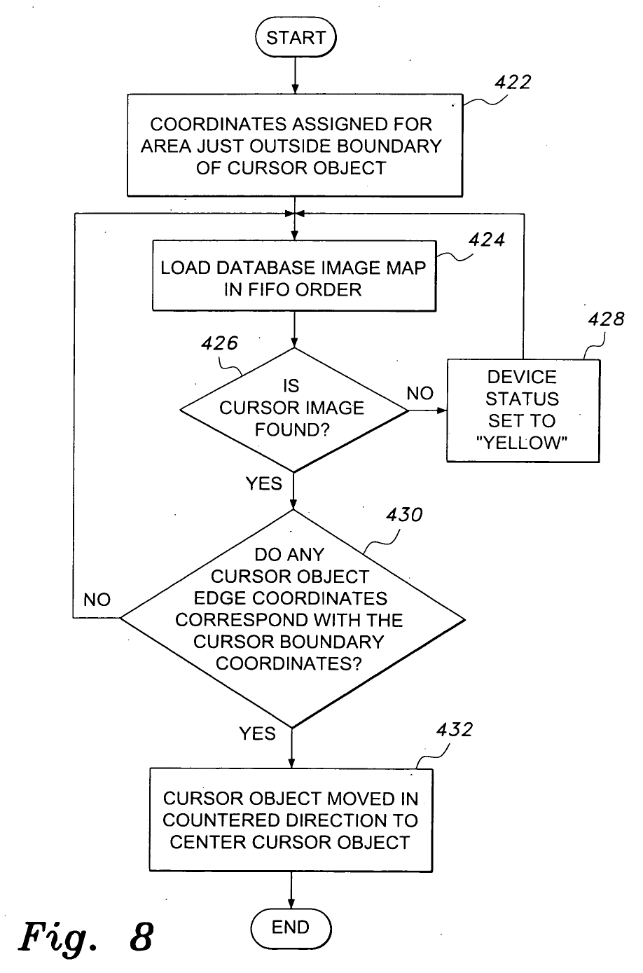

Once the device 10 is “locked”, the processor 202 is able to take into account movement of the device 10 and move the cursor image 102 directly with the device 10. Turning now to FIG. 8, a flowchart is shown that describes how the software maintains the cursor image 102 aligned with the line of sight 14 when the input device 10 is subsequently moved to point to a different location on the display 100.

After the pointing device 10 is “locked”, at 422, coordinates are assigned for the area just outside the boundary of the cursor object 102 and saved as a cursor boundary dataset. The device 10 may then be moved, and at step 424, the database image map is again loaded in FIFO order, essentially updating the movement of the device 10. The software determines whether the cursor image 102 is found within the images loaded at 426. If the cursor image 102 is not found, the device status light 60 is set to “yellow” at step 428 and the database image map is again loaded until the cursor image 102 is found. If the cursor image 102 is found, at 430, then the cursor object edge coordinates, determined at 412, are compared to the cursor boundary dataset. If any of the cursor object edge coordinates correspond with the cursor boundary coordinates, then the one edge has overlapped the other and, at 432, the cursor object 102 is moved in a countered direction until the cursor object 102 is again centered in the field of vision of the computer pointing input device 10.

In the second method of aligning the cursor image 102 with the device 10, the device 10 is first “locked” onto the cursor image. 102. Before the device 10 is activated, the user holds the device 10 in such a way that the line of sight 104 of the device 10 aligns with the cursor image 102 displayed on the monitor 214. The device 10 is then activated, and the processor 202 is notified that the device 10 has zeroed onto the cursor image 102, signifying that the device 10 is “locked” to the cursor image 102. Although the device 10 should generally zero in on the center of the cursor image 102, the device 10 may be zeroed at any point at which the user intends to align the line of sight of the device 10 and the display 100.

In this example, the array component 22 and the array aperture 24 are used in conjuncture with the device's internal processing unit 18. The illuminators 38 direct illumination onto a surface in front of the device 10, for example, display 100, if the image is intended to be captured through the front aperture 28. The illumination components 38 illuminate a surface in back of the device 10, for example, image 300 shown in FIG. 3, if the image is intended to be captured through the rear aperture 32. The image-capturing component 16 continuously acquires images through the front or rear aperture 28 or 32 of the device 10, and focuses the image onto the array component 22. The images are then converted by the internal processing unit 18 to a format readable by the processor 202. The information is conveyed to the processor 202 by the wired or wireless communication device 26. Successive images are compared, and the processor 202 is able to determine changes in the direction of the device 10 based on the slight variations noted between successive images acquired as a result of the movement of the device 10 away from the zeroed point determined at the first “locked” position. The processor 202 will then move the cursor object 102 based on the movement of the device 10 in the x or y direction.

While the foregoing description relates that the device 10 is moved relative to a fixed monitor 214, allowing for the acquisition of multiple images that may be compared, alternatively the device 10 may be held stationary, and the images may be acquired and compared through movement of the surface from which the images are being obtained relative—to the device 10 itself. For example, the device 10 may be held near a user's face at a position close to the user's eyes. The pointing device 10 may be set in such a manner that the device 10 may acquire images of the eye's position relative to a “zeroed” point to determine the direction the cursor image 102 is to move.

In a third method, the device 10 uses infrared, ultrasonic, or radio transmitters in conjunction with a sensor array 90 attached to the monitor 212 to determine the line of sight 14 of the device 10. The device 10 may also make use of a magnetic field in conjunction with a sensor array 90 to determine the line of sight 14 of the device. When the input device 10 is moved, the cursor image 102 is directed by the processor 202 to move in correspondence to positions mathematically determined by the intersection of an imaginary line projected through points at the front end 30 and back end 34 of the device 10 with the display 100. Use of the infrared, ultrasonic, radio or magnetic transmitters does not require the use of the internal array component 22 or the array aperture 24, and may not require use of the internal processing unit 18. While the projection of an imaginary line through points at the front 30 and back 34 of the device 10 is disclosed, the position of the device 10 may be determined through any method that uses transmitters situated on the device 10 and a sensor array 90. For example, numerous transmitters may be used anywhere on the device 10, not necessarily in the front 30 and rear 34 ends of the device 10, so long as an imaginary line extending through points on the device 10 may be projected to extend toward, and intersect with the display 100.

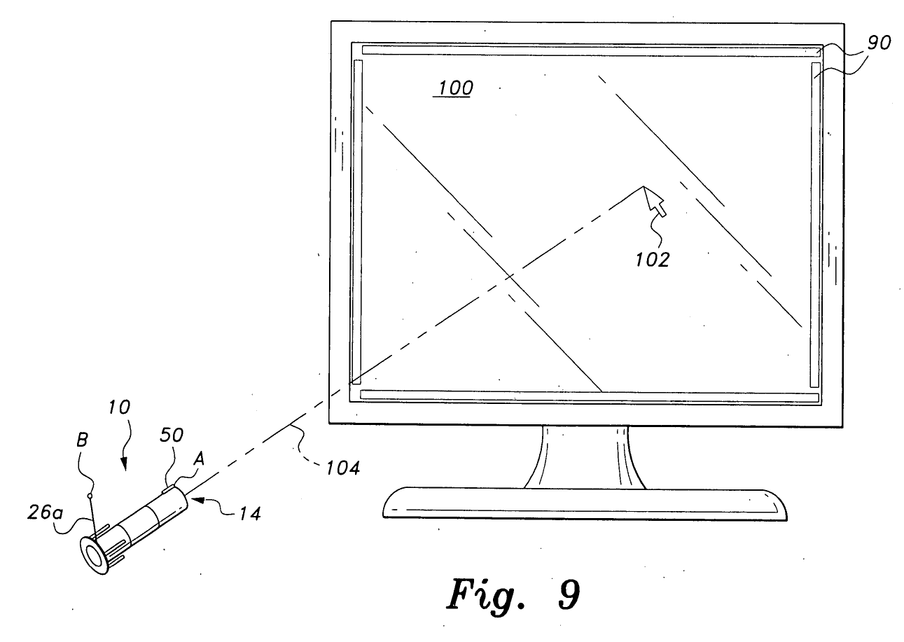

Turning now to FIG. 9, the computer pointing input device 10 is shown being used with a sensor array 90. The sensor array 90 is attached directly to, closely adjacent to, or directly in front of the computer monitor 214 and is coupled to the processor 202. The sensor array 90 includes multiple receivers able to pick up signals sent from the computer pointing input device 10. The cursor command unit 50 contains an infrared, ultrasonic, radio or magnetic transmitter that is able to transmit a first signal or magnetic field from point A, which is the front end 30 of the device 10, to the sensor array 90. The wireless communication device, transmitter 26a, is able to transmit a second signal from point B, which is the back end 34 of the device 10, to the sensor array 90. The signals emitted from points A and B are picked up by the sensor array 90 that is able to triangulate their positions above the reference plane, which is the display monitor 214. In alternate embodiments, the sensor array 90 may be positioned on a desk top, behind the device 10 or in any location so that the sensor array 90 can pick up the signals sent by the transmitters to the sensor array 90 and then determine the position of the input device 10 in relation to the display 100.

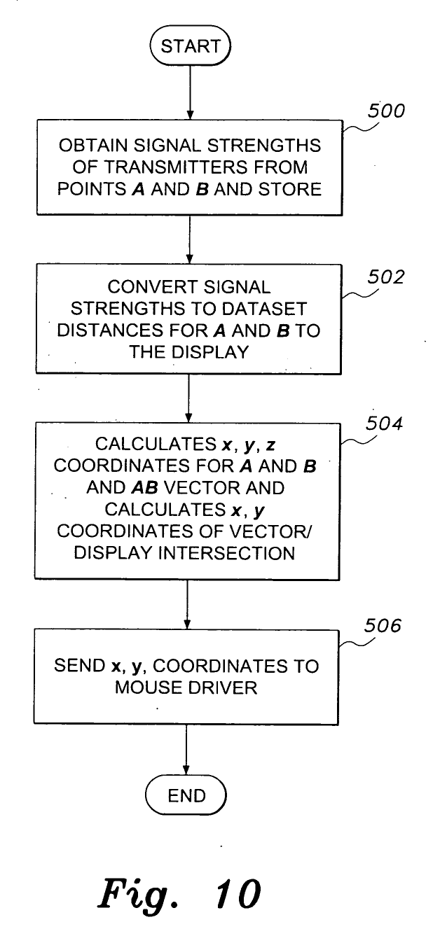

FIG. 10 shows a flowchart of the method of aligning the cursor image 102 with the line of sight 104 of the device 10 using a sensor array 90. At step 500, the signal strengths of the transmitters at point A and point B are obtained by the sensor array 90, sent to the processor 202 and stored in a dataset. The signal strengths are converted to dataset range distances from point A to the display 100 and point B to the display 100 at 502. At 504, the x, y, and z coordinates are calculated for point A and point B above the display 100 and an AB vector is calculated through points A and B. Then the x and y coordinates of the intersection of the AB vector and the display 100 are determined. The x and y coordinates of the vector/display intersection are sent to the processor 202 to direct the computer's mouse driver to move the cursor image 102 in relation to the vector/display intersection. While two points A and B are discussed, any number of transmitters may be used on the device, as long as an imaginary line that intersects the display 100 can be projected through two or more points on the device 10 that intersects the display 100, thereby allowing the processor 202 to ascertain the line of sight of the device 10 and direct the mouse cursor 102 to move to a position determined by the intersection of the imaginary line and the display 100.

The cursor command unit 50 (shown in FIGS. 1 and 3-5) allows a user to operate the computer pointing input device 10 without traditional mouse buttons. Virtual invocation of mouse functions allows for increased efficiency in performing the functions, as virtual invocation is more ergonomic than the typical electromechanical configuration of a mouse. The cursor command unit 50 is equipped with an infrared transmitter/receiver unit or any other type of transmitting and receiving unit that would allow for a signal to be sent to and received from the display 100.

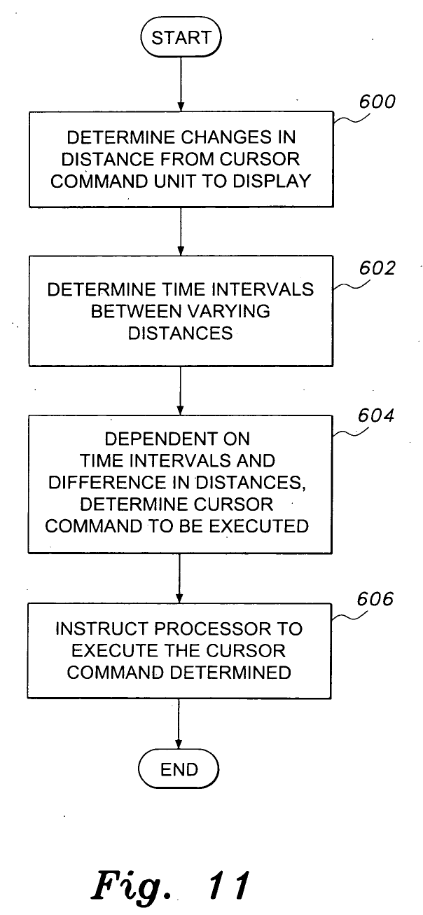

FIG. 11 shows a flowchart of the method by which cursor commands may be executed. A signal is transmitted from the cursor command unit 50 and reflected back to the unit 50. When the device 10 is moved between a first distance and a second distance, the difference in time for the signal to return to the cursor command unit 50 is noted either by a processing unit within the cursor command unit 50, by the internal processing unit 18 within the device 10 to which the cursor command unit 50 may be coupled, or by the computer processor 202 to which information is sent by the cursor command unit 50. Either the processor 202, the cursor command unit 50 or the internal processing unit 18 is able to determine changes in distance from the cursor command unit 50 to the display 100 at 600. At step 602, time intervals between varying distances are also determined. The information as to varying distances and time intervals is sent to the processor 202 by the wired or wireless communication device 26. Dependent on the difference in distances and the time intervals between various distances, the cursor command to be executed is determined at 604. At 606, the processor 202 is instructed to execute the cursor command determined.

An example illustrating the above method is as follows. The device 10 is moved from a first position, D1, to a second position, D2. The device 10 is maintained at the D2 position for a one second interval and then returned to the D1 position. The processor 202 would determine the cursor command, for example a “left click” command, based on the spatial difference between D1 and D2 and the timing interval maintained at D2 before returning the device to position D1.

While the line of sight 104 of the device 10 has been shown as the front aiming point of the device 10, the line of sight 104 may be from any aiming or other point on the device 10 located at any position appropriate for the user.

It is to be understood that the present invention is not limited to the embodiments described above, but encompasses any and all embodiments within the scope of the following claims.

I claim:

1. A computer pointing input device, comprising:
a housing; and
means for controlling position of a cursor image on a computer display by a line of sight of the device.

2. The computer pointing input device according to claim 1, further comprising means for obtaining a plurality of images of a surface.

3. The computer pointing input device according to claim 2, wherein the means for obtaining a plurality of images of a surface comprises an image-capturing component disposed within the housing.

4. The computer pointing input device according to claim 2, further comprising means for converting the images obtained to a plurality of signals.

5. The computer pointing input device according to claim 4, wherein the means for converting the images to a plurality of signals comprises a circuit disposed within the housing.

6. The computer pointing input device according to claim 4, further comprising means for communicating the signals to a computer processor.

7. The computer pointing input device according to claim 6, wherein the means for communicating the signals to a computer processor comprises a transmitter disposed within the housing.

8. The computer pointing input device according to claim 6, wherein the means for communicating the signals to a computer processor comprises a cable extending from the housing.

9. A method of maintaining a cursor image in alignment with a line of sight using the input device of claim 2, comprising the steps of:
obtaining a picture of a computer display;
determining whether the cursor image has been found within the picture obtained;
determining whether the center of the cursor image is located within a center zone of the picture;
in response to a determination that the center of the cursor image is located within a center zone of the picture, notifying the processor that the cursor image is aligned with the center of the line of sight of the device; and
upon successive movement of the device, maintaining the cursor image along the line of sight of the device.

10. A method of maintaining a cursor image in alignment with a line of sight using the input device of claim 2, comprising the steps of:
positioning the input device in relation to the cursor image in such a manner as to align the line of sight of the input device with the cursor image;
notifying the processor that the cursor image is aligned with the center of the line of sight of the device;
obtaining at least two images having a plurality of common features through an aperture defined within the input device;
correlating at least two images to detect differences in location of the common features within the images; and
based on the differences detected within the images, directing the processor to position the cursor image in relation to the changes in location of the features.

11. The computer pointing input device according to claim 1, further comprising:
means for determining an imaginary line projected through at least two points on the input device;
means for determining coordinates of a position determined by intersection of the projected imaginary line with the computer display; and
means for positioning the cursor image at the position determined by the intersection of the projected imaginary line with the computer display.

12. A method of maintaining a cursor image in alignment with a line of sight using the input device of claim 11, comprising the steps of:
obtaining signal strengths of at least two transmitters located at two points on the input device from a plurality of receivers;
converting the signal strengths to range distances for each transmitted signal;
projecting an imaginary line through the at least two transmitter points on the device;
determining coordinates of an intersection between the projected imaginary line with the computer display; and
directing the processor to position the cursor image at said intersection of the projected imaginary line and the display.

13. A system for virtually determining cursor commands, comprising:
a computer processor;
a cursor command unit in communication with the computer processor;
means for emitting a plurality of signals from the cursor command unit;
means for determining changes in distance from a first position of the cursor command unit to a second position of the cursor command unit in relation to a computer display and determining time intervals between the first position and second position; and
means for directing the processor to execute a specific cursor command based on changes in distance and the time intervals.

14. A method of virtually determining cursor commands using the system of claim 13, comprising the steps of:
emitting a signal from a cursor command unit;
determining changes in distance from a first position of the cursor command unit to a second position of the unit in relation to a computer display;
determining time intervals between the first position and the second position;
based on the changes in distance and the time intervals, directing the processor to execute a specific cursor command.
